(19) United States
(12) Patent Application Publication
(10) Pub. No.: US 2021/0370213 A1
(43) Pub. Date: Dec. 2, 2021

(54) AIR FILTRATION SYSTEMS, METHODS, AND APPARATUSES

(71) Applicants: Joseph Priorello, Scottsdale, AZ (US); Elham H. Fini, Phoenix, AZ (US)

(72) Inventors: Joseph Priorello, Scottsdale, AZ (US); Elham H. Fini, Phoenix, AZ (US)

(21) Appl. No.: 17/323,621

(22) Filed: May 18, 2021

Related U.S. Application Data
(60) Provisional application No. 63/031,348, filed on May 28, 2020.

(51) Int. Cl. B01D 46/00; B01D 39/18

(52) U.S. Cl. CPC B01D 46/0028; B01D 39/18; B01D 46/0002; B01D 2279/50; B01D 2239/0442; B01D 2239/0492; B01D 2257/504; B01D 46/0036

(57) ABSTRACT

An air filter apparatus may comprise a frame and a hemp-based filter disposed within the frame. The hemp-based filter is configured to sequester carbon dioxide in response to air flowing through the hemp-based filter.

### CROSS-REFERENCE TO RELATED APPLICATIONS

This application is a non-provisional of, and claims priority to and the benefit of U.S. Provisional Application No. 63/031,348, entitled “Carbon Negative Air Filter,” filed on May 28, 2020. The disclosure of the foregoing application is incorporated herein by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to air filters, and in particular to air filters using hemp-based materials.

### BACKGROUND

Existing air filters may be made of spun fiberglass, pleated paper or cloth that is framed within cardboard. There is not a fully bio-based and sustainable air filter on the market that can absorb carbon dioxide (CO₂) along with debris to improve indoor air quality by reducing CO₂ concentration. High carbon dioxide levels in indoor air can have negative health effects on occupants, specifically on their cognitive function. The ability of a filter to sequester carbon dioxide throughout an existing building system while removing debris and other air contaminants may provide an advantage over existing commercial air filters.

Conventional air filters may be used to trap debris and dust. The conventional air filters do not reduce CO₂ in indoor air. Breathing air having high concentrations of CO₂ may have negative effects on cognitive ability. Accordingly, reducing CO₂ concentrations may have advantages and health benefits, especially in high occupancy facilities.

### SUMMARY

An air filter apparatus is disclosed herein. The air filter apparatus comprises: a frame; and a hemp-based filter disposed within the frame, the hemp-based filter configured to sequester carbon dioxide in response to air flowing through the hemp-based filter.

In various embodiments, the hemp-based filter comprises a hemp hurd. The frame may comprise hemp-based paper. The air filter apparatus may further comprise a first outer skin disposed on a first side of the frame and the hemp-based filter and a second outer skin disposed on a second side of the frame and the hemp-based filter. The hemp-based filter may be enclosed within the frame, the first outer skin, and the second outer skin. The first outer skin may define an inlet to the air filter apparatus and the second outer skin defines an outlet to the air filter apparatus. The hemp-based filter may include a coating disposed thereon, and the coating may include antibacterial properties. The coating comprises plant-based essential oils. The coating may comprise a hemp-based essential oils.

An air filtration system is disclosed herein. The air filtration system may comprise: a housing; a fan disposed within the housing; an air filtration apparatus disposed within the housing, the air filtration apparatus comprising a hemp-based filter, the fan configured to pull air through the housing and the air filtration apparatus and exhaust a filtered air through an outlet of the air filtration system.

In various embodiments, the hemp-based filter may include a hemp hurd. The hemp hurd may be a compressed hemp hurd. The air filtration apparatus may further comprise a frame, the hemp hurd disposed within the frame. The air filtration system may further comprise a first outer skin disposed adjacent a first side of the frame and a second outer skin disposed adjacent a second side of the frame. The hemp hurd may be enclosed within the frame, the first outer skin and the second outer skin. The hemp-based filter is configured to absorb carbon dioxide. The air filtration system may further comprise a plant-based coating disposed on the hemp-based filter. The plant-based coating may be a hemp-based coating.

A method of manufacturing an air filtration apparatus is disclosed herein. The method may comprise: disposing a hemp hurd within a frame; coupling a first outer skin to a first side of the frame; coupling a second outer skin to a second side of the frame, the hemp hurd being enclosed by the frame, the first outer skin, and the second outer skin.

In various embodiments, the method further comprises coating the hemp hurd with a plant-based coating, the plant-based coating including antibacterial properties.

### BRIEF DESCRIPTION OF THE DRAWINGS

With reference to the following description and accompanying drawings:

FIG. 1A illustrates a front view of an exemplary hemp-based filter in accordance with various exemplary embodiments;

FIG. 1B illustrates a cross-sectional view of an exemplary hemp-based filter in accordance with various exemplary embodiments;

FIG. 2A illustrates a front view of an exemplary hemp-based filter in accordance with various exemplary embodiments;

FIG. 2B illustrates a cross-sectional view of an exemplary hemp-based filter in accordance with various exemplary embodiments;

FIG. 3 illustrates a perspective cross-sectional view of a portion of a heating, ventilation, and cooling (HVAC) system, in accordance with various exemplary embodiments;

FIG. 4 illustrates a schematic view of an air filtration system, in accordance with various exemplary embodiments; and

FIG. 5 illustrates a flow chart for a method of manufacturing an exemplary hemp-based filter, in accordance with various embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments, including the best mode. As will become apparent, various changes may be made in the function and arrangement of the elements described in these embodiments without departing from principles of the present disclosure.

For the sake of brevity, the connecting lines shown in various figures contained herein are intended to represent exemplary functional relationships and/or physical couplings between various elements. It should be noted that many alternative or additional functional relationships or physical connections may be present in air filters using hemp-based materials, including hemp hurd, hemp oil, and/or other hemp or fiber plant materials.

Disclosed herein are air filtration systems, methods, and devices. In various embodiments, the air filtration systems and devices are configured to capture carbon dioxide (CO₂). In this regard, the air filtration systems and devices include a carbon dioxide absorbing component as described further herein. In various embodiments, the carbon dioxide absorbing component is a hemp hurd. Although described herein as comprising a hemp hurd, other components of a hemp stalk being utilized for a carbon dioxide absorbing component is within the scope of this disclosure. For example, hemp fiber, shivs, leaves, roots, or the like may be utilized in part or in combination with a carbon dioxide absorbing component of an air filtration system or device.

In various embodiments, by absorbing CO₂ and sequestering CO₂ within air filtration and other air ventilation type systems, carbon emissions in the atmosphere may be reduced. According to the National Aeronautics and Space Administration (NASA), this has been another harmful effect of increased CO₂ levels that had not been taken into account until recently. The construction industry and building sector may be responsible for 40% of carbon emissions each year, with another 8% coming from the transport of construction materials to building sites. Since 2010, building-related carbon emissions have risen by 1% each year. New construction worldwide is expected to add an astronomical 2.47 trillion square feet of indoor space in the next 40 years. This would account for a significant increase in CO₂ emission. While there is no single overarching solution to address this issue, integration of multiple solutions into the building industry could alleviate the problem. Thus, air filtration systems, methods, and devices disclosed herein address a long felt need of reducing carbon emissions, which has been persistent, and not solved by others.

In various embodiments, the air filtration systems and devices disclosed herein include antibacterial properties. “Antibacterial properties” as described herein refers to reducing the growth and/or spread of bacteria relative to a system or device without antibacterial properties. Typical air filtration systems and devices include remove dust and air particles during operation. The air filtration systems and devices closed herein remove dust and air particles, and further may be configured to absorb carbon dioxide and kill at least a portion of bacteria and/or viruses via the air filtration system and device's antibacterial properties. In this regard, air filtration systems and devices disclosed herein may diminish transmission of diseases among occupants of the same household or apartment complex, as well as reduce carbon emissions in the atmosphere related to the construction industry and building sector. In various embodiments, the air filtration systems and devices may include antiseptic properties and/or offer a healthy alternative to typical air filtration systems and devices. The air filtration systems and devices may be carbon neutral, biodegradable, and/or antiseptic, while being able to filter dust and lint in accordance with typical air filtration systems and devices.

Some fiber plants, especially hemp, demonstrate antibacterial properties. For example, hemp has been shown to provide antibacterial properties against a wide range of pathogenic bacteria. Studies of antimicrobial activity of several essential oils have demonstrated that hemp essential oil may reduce bacterial proliferation, thus proving to be a valid support to reduce microorganism contamination. Therefore, a hemp air filter may have added health advantages while promoting sustainability and resource conservation.

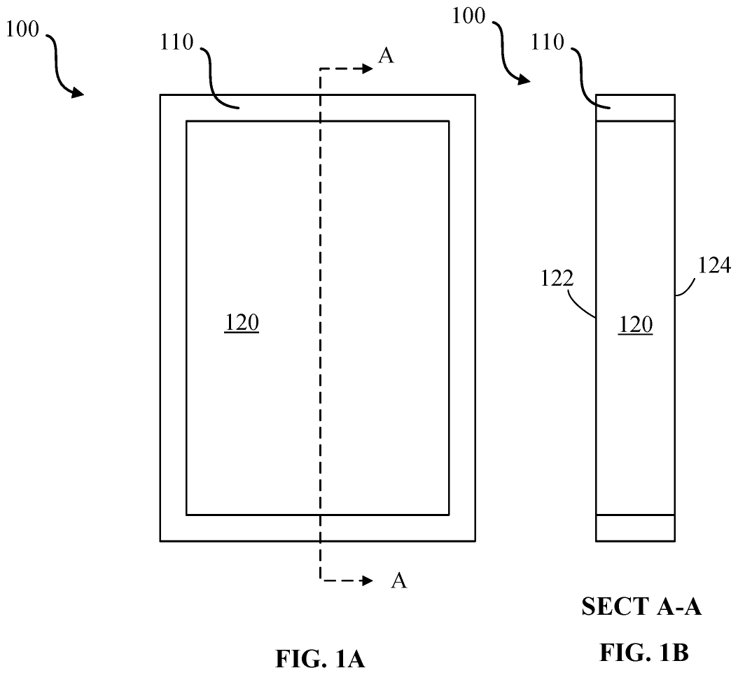

Referring now to FIG. 1A, a front view of an air filtration apparatus 100 is illustrated, in accordance with various embodiments. In various embodiments, the air filtration apparatus 100 is a hemp-based air filter. In various embodiments, the air filtration apparatus 100 is a CO₂ airflow capture. In various embodiments, the air filtration apparatus 100 uses plant-based oil coatings for the plant-based oil coatings' natural antibacterial properties. In various embodiments, the air filtration apparatus 100 is configured to capture viruses. In various embodiments, the air filtration apparatus uses recycled materials to increase sustainable aspects. The air filtration apparatus 100 includes a frame 110 and a filter 120.

In various embodiments, the frame 110 may structurally support the filter 120. In various embodiments, the frame 110 may contribute to filtering functions of the air filtration apparatus 100. For example, in various embodiments, the frame 110 may be manufactured from hemp products as well, such as hemp paper, or the like. In various embodiments, the frame 110 may be made for industrial use and include metal construction, or any other frame for structurally supporting filters.

In various embodiments, the frame 110 surrounds and encloses the filter 120. In this regard, frame 110 may create a border around the filter 120, in accordance with various embodiments. Although described herein as including frame 110, the air filtration apparatus 100 of the present disclosure is not limited in this regard. For example, any air filtration apparatus includes a filter 120 as described herein that is configured to absorb CO₂ during operation and/or remove bacteria/viruses, with or without a frame 110, is within the scope of this disclosure.

In various embodiments, the frame 110 comprises hemp paper. “Hemp paper,” as disclosed herein refers to pulp obtained from fibers of industrial hemp. Hemp paper may be similar to specialty papers, such as cigarette paper, banknotes, and technical filter papers. Compared to wood pulp, hemp pulp offers a four to five times longer fiber, a significantly lower lignin fraction, as well as a higher tear resistance and tensile strength. In this regard, hemp paper may act as a strong structural support for the filter 120, maintain biodegradable properties similar to filter 120, and/or contribute to carbon capture of the air filtration apparatus 100, in accordance with various embodiments.

In various embodiments, the filter 120 comprises hemp hurds. “Hemp hurds” as disclosed herein, refers to inner core fibers of hemp stalk. In various embodiments, the hemp hurds of filter 120 may be compressed to a predetermined density, prior to being installed within the frame 110. In various embodiments, the predetermined density may be determined based on a correlation to CO₂ absorption, cost, weight, or any combination of the aforementioned variables.

Referring now to FIG. 1B, a cross-sectional view of the air filtration apparatus 100 is illustrated, in accordance with various embodiments. In various embodiments, the filter 120 defines an air inlet 122 and an air outlet 124. In this regard, “dirty air” or “unpurified air” may be configured to enter the filter 120 through the air inlet 122, the filter 120 then absorbs CO₂ from the unpurified air and/or removes bacteria/viruses from the unpurified air, and outputs purified air through the air outlet 124. In various embodiments, air may also travel through the frame 110 (i.e., when the frame is made from hemp paper).

In various embodiments, the filter 120 may provide air filtration functions due to its material properties (i.e., via the hemp hurd(s)). For example, the hemp hurds may passively collect dust, debris, and airborne contaminants such as bacteria and viruses. The hemp hurds may also absorb CO₂ and may be better than other filtering material because of the additional ability to capture CO₂ to further enhance air quality, in addition to filtering dust and debris particulates as traditional air filters. In various embodiments, the air filtration apparatus 200, in its entirety, is biodegradable.

The thickness, width and height of the air filter apparatus 100 may vary, depending on the size of the system the filter may be intended to be installed into.

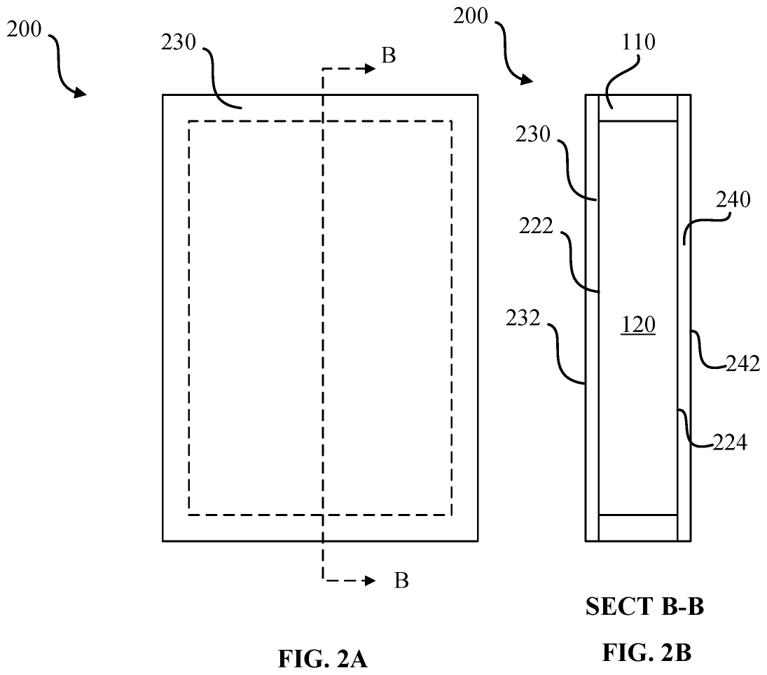

Referring now to FIGS. 2A and 2B, a front view (FIG. 2A) of an air filtration apparatus and a cross-sectional view along section line B-B (FIG. 2B) of an air filtration apparatus is illustrated, in accordance with various embodiments. In various embodiments, the air filtration apparatus 200 comprises a frame 110, a filter 120, a first outer skin 230, and a second outer skin 240. In various embodiments, the first outer skin 230 is disposed on a first side 222 of the air filter 120 and the second outer skin 240 is disposed on a second side 224 of the air filter 120. In various embodiments, the outer skins 230, 240 and the frame 110 structurally support the air filter 120 and/or hold the air filter 120 in place. In various embodiments, each component of the air filtration apparatus 200 (i.e., the frame 110, the filter 120, the outer skins 230, 240) is configured to absorb CO₂ to some extent. In various embodiments, the first outer skin 230 defines an air inlet 232 and the second skin 240 defines an air outlet 242. In this regard, outer skins 230, 240 may facilitate air flowing through the filter 120 for CO₂ sequestration and/or bacteria/virus removal, in accordance with various embodiments.

In various embodiments, the air filter apparatus 100, 200 is an indoor air filter using hemp-based materials. The indoor air filter using hemp-based materials may have the ability to purify the air along with removing CO₂ gas molecules. As illustrated, the air filter apparatus 100, 200 may include a hemp paper framework including sustainable hemp hurds installed inside the hemp paper framework. In this regard, the air filter apparatus 100, 200 may provide added health advantages while promoting sustainability and resource conservation, in accordance with various embodiments.

In various embodiments, the air filter apparatus 100, 200 is designed to address the long felt need for enhanced indoor air-quality, carbon sequestration, resource conservation and sustainable material development. The air filter apparatus 100, 200 may include development of disposable air filters that may be used in routine building maintenance. For example, air filter apparatus 100, 200 may use raw hemp hurds as a filter media. Hemp hurds are a sustainable agricultural product produced from the woody inner parts of the hemp stalk. Raw hemp hurds may sequester carbon dioxide. Accordingly, a filter using hemp hurds may not only provide air filtration for debris, but may also enhance air quality by reducing CO₂ concentration. Accordingly, the proposed filter may have added health benefits for building occupants.

In various embodiments, the filter 120 of the air filtering apparatus 100, 200 includes a sustainable air filter made from hemp-fiber for use in building environments (e.g., home and/or commercial buildings) or portable filter devices as described further herein. The air filter apparatus 100, 200 includes an air filter 120 that has the ability to filter air to the same standard as traditional air filters while also absorbing CO₂. The air filter 120 may sequester CO₂ while also filtering out other contaminants. The air filter 120 may be made of a sustainable material that may be cost effective. Such an air filter apparatus 100, 200 has the potential to replace conventional indoor air filters. A hemp-based filter may be installed as part of an air delivery system as described further herein. Such systems may include but are not limited to HVAC systems and/or portable air filtering devices.

In various embodiments air filter apparatus 100, 200 includes hemp hurds installed inside of a hemp paper frame in order to make a disposable, sustainable air filter that has all of the same qualities of a standard air filter with the added ability of absorbing CO₂. In an embodiment, the air filter apparatus 100, 200 may have common dimensions matching present system infrastructure. Outer skins 230, 240 of the air filter apparatus 200 may include recycled papers which may be used to hold the hemp hurds of air filter 120 in place. The air filter apparatus 100, 200 filter may use recycled paper to facilitate air passing through the hemp hurds. Hemp hurds may be a scavenger of CO₂ and air-borne contaminants.

In various embodiments, the air filter 120 (e.g., hemp hurds) may be coated with hemp-based essential oils in order to increase the antibacterial properties of the air filter apparatus 100, 200. The coating provides a plant-based essential organic oil coating that may have natural antibacterial properties and possibly antifungal protection as well. Accordingly, in various embodiments, the air filter apparatus 100, 200 is a bio-based filter made from hemp coated in hemp-based essential oils to sequester carbon dioxide in addition to typical debris and air contaminants.

In various embodiments, the air filter apparatus 100, 200 may be configured to filter in an area or room. The area or room may have a higher concentration of oxygen gas molecules due to the filtering using hemp hurds. Accordingly, in various embodiments, the filters described herein may provide for potential enhanced cognitive abilities for people using such filters because of higher concentrations of oxygen gas molecules.

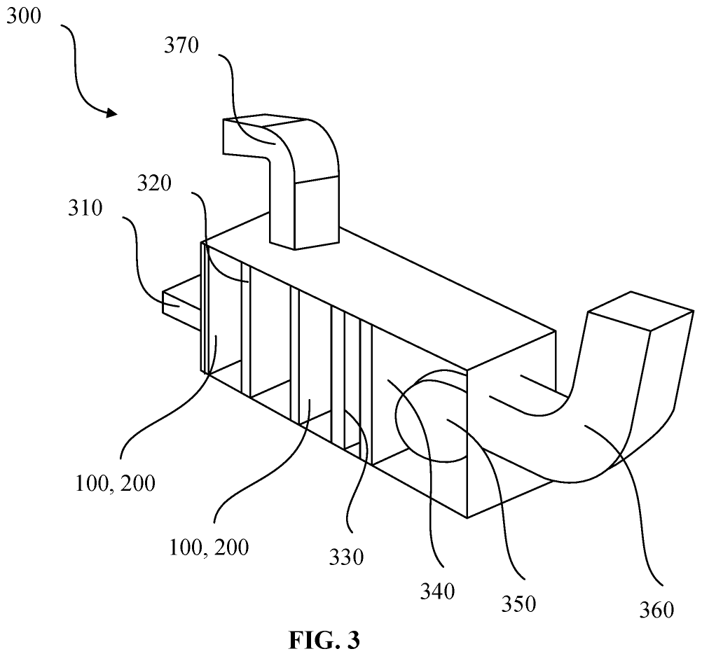

Referring now to FIG. 3, a cross-section perspective view of a portion of a heating, ventilation and cooling (HVAC) system is illustrated, in accordance with various embodiments. In various embodiments, an HVAC system 300 may comprise at least one air filtration apparatus 100, 200 as disclosed herein. For example, an air filtration apparatus 100, 200 may be disposed proximate an air inlet conduit 310. In various embodiments, the air filtration apparatus 100, 200 may be disposed between the inlet conduit 310 and a preheat coil 320 of the HVAC system. In various embodiments, an air filtration apparatus 100, 200 may be disposed between the preheat coil 320 and a cooling coil 330. In various embodiments, the HVAC system 300 may further comprise a fan 350, a re-heat coil 340 disposed between the fan 350 and the cooling coil 330, an outlet conduit 360 disposed proximate the fan 350, and a return conduit 370.

In various embodiments, the air filtration apparatus 100, 200 may be disposed proximate an outlet of outlet conduit 360. In this regard, the air filtration apparatus 100, 200 may provide a final filtering of air prior to entering a room that is being air conditioned via the HVAC system 300, in accordance with various embodiments.

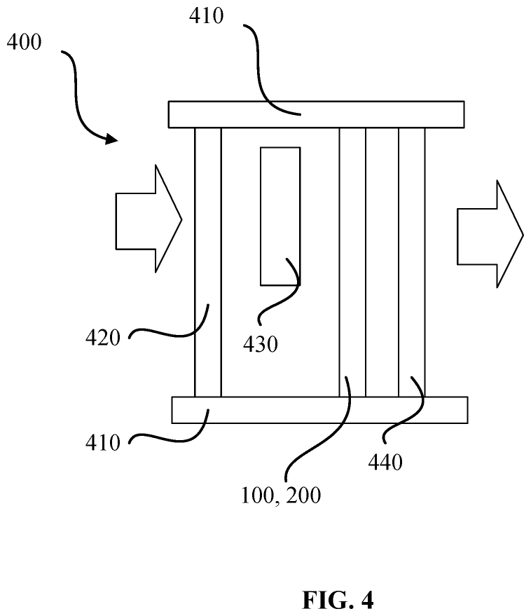

Referring now to FIG. 4, a schematic view of an air filtration system 400 is illustrated, in accordance with various embodiments. The air filtration system 400 includes an air filtration apparatus 100, 200. The air filtration apparatus 100, 200 is disposed within a housing 410 (or enclosure), which is configured to receive air therethrough. In this regard, the housing 410 may comprise a fan 430 configured to pull air through the housing 410. In various embodiments, the air filtration system 400 may comprise a pre-filter 420 disposed proximate an inlet of the air filtration system and/or a post-filter 440 disposed proximate an outlet of the air filtration system 400. In various embodiments, the pre-filter 420 and post-filter 440 may be made of foam or the like. In various embodiments, the pre-filter 420 and the post-filter 440 may be in accordance with the air filtration apparatus 100, 200 (i.e., the pre-filter 420 and the post-filter 440 may both be hemp-based filter).

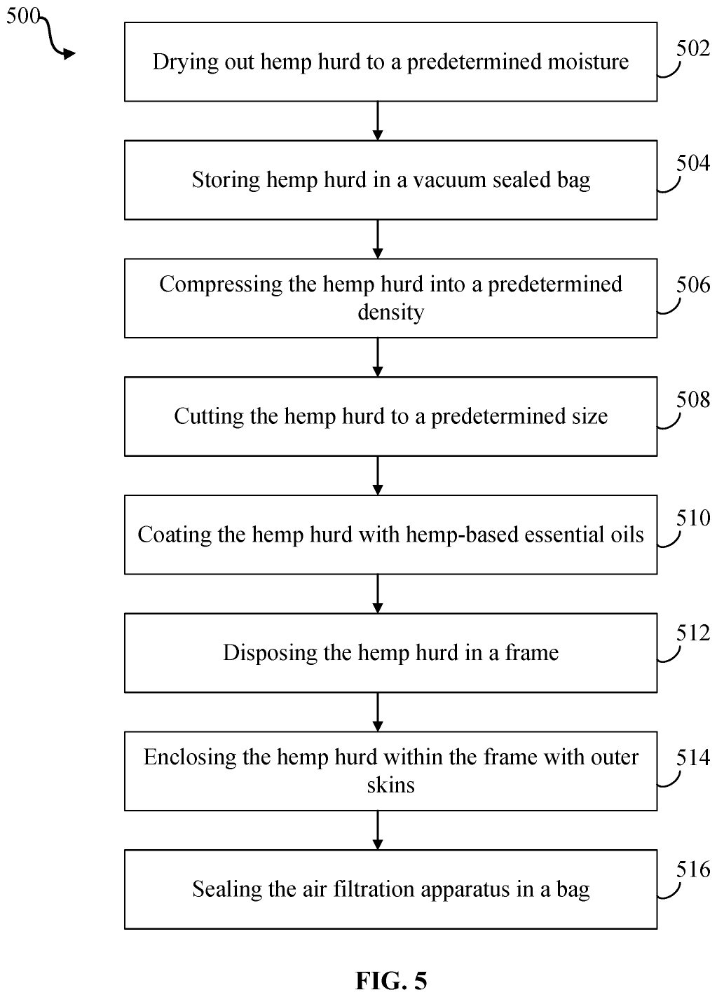

Referring now to FIG. 5, a method of producing an air filtration apparatus 100, 200 is illustrated, in accordance with various embodiments. In various embodiments, the method 500 comprises drying out a hemp hurd to a predetermined moisture (step 502). This step may be performed directly after harvesting the hemp. In various embodiments, the method 500 further comprises storing the hemp hurd in a vacuum sealed bag (step 504). In various embodiments, steps 502 and 504 may be performed prior to manufacturing the air filtration apparatus 100, 200. In this regard, the hemp hurd may be stored in the vacuum sealed bag to maintain the CO₂ sequestration capability for an extended period of time prior to manufacturing a specific air filtration apparatus 100, 200.

In various embodiments, the method 500 further comprises compressing the hemp hurd into a predetermined density (step 506) and cutting the hemp hurd to a predetermined size (step 508). In various embodiments, a density of the hemp hurd may correlate to a sequestration capability of the hemp hurd. In this regard, a density may be determined based on an optimal sequestration capability of the hemp hurd, in accordance with various embodiments. The predetermined size may be determined based on various applications as disclosed previously herein. Varying the size of these filters may allow for use in portable air filter systems including inverse blowers that may be transported to areas, buildings, stores, homes, or other locations.

In various embodiments, the method 500 further comprising coating the hemp hurd with hemp-based essential oils (step 510). In various embodiments, the hemp based essential oils may comprise antiseptic properties. “Antiseptic properties” as disclosed herein include properties configured to stop or slow down the growth of micro-organisms. In various embodiments, the hemp-based essential oils may comprise anti-bacterial properties. In this regard, the hemp based essential oils may be configured to remove and/or kill bacteria in response to air flowing through the hemp-based essential oils. Although described herein with respect to hemp-based essential oils, the present disclosure is not limited in this regard. For example, any plant-based essential oils having antiseptic and/or anti-bacterial properties is within the scope of this disclosure. By using hemp-based essential oils though, a fully biodegradable, carbon neutral (or carbon negative) air filtration device 100, 200 may be formed from method 500, in accordance with various embodiments.

In various embodiments, the method 500 further comprises disposing the hemp hurd in a frame (step 512). In various embodiments, the frame may be in accordance with frame 110 from FIGS. 1A-2B. In various embodiments, the hemp hurd may be press fit into the frame. In various embodiments, the hemp hurd may be coupled to the frame, via an adhesive or any other method of coupling.

In various embodiments, the method 500 further comprises enclosing the hemp hurd within the frame by coupling outer skins on opposite sides of the frame (step 514). In various embodiments, the outer skins may be hemp-based (e.g., hemp paper or the like). In various embodiments, the outer skins may facilitate airflow through the hemp hurds. In this regard, the outer skins may be somewhat porous and configured to allow air to flow therethrough. The resultant air filter apparatus 100, 200 may be tailored to trap a variety of airborne viruses in order to keep the viruses from circulating in the air. Additionally, the filter may possibly inactivate the viruses.

In various embodiments, the method 500 further comprises sealing the air filtration apparatus in a bag (step 516). In various embodiments step 516 allows the resultant air filtration apparatus to maintain its CO₂ sequestration capabilities until installed (e.g., in an HVAC system 300 from FIG. 3 or an air filtration system 400 of FIG. 4).

When in use, the filter may have a life of between 30-90 days, at which point the filter may be disposed of. The air filter use duration of 30 to 90 days may be similar to a typical use duration of standard available air filters.

This type of technology has potential applications for increasing the air quality benefits for everyday use by people, especially in high occupancy areas or small spaces within their homes, restaurants, gyms, shopping stores, hospitals, and other commercial buildings.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. An air filter apparatus, comprising:
a frame; and
a hemp-based filter disposed within the frame, the hemp-based filter configured to sequester carbon dioxide in response to air flowing through the hemp-based filter.

2. The air filter apparatus of claim 1, wherein the hemp-based filter comprises a hemp hurd.

3. The air filter apparatus of claim 1, wherein the frame comprises hemp-based paper.

4. The air filter apparatus of claim 1, further comprising a first outer skin disposed on a first side of the frame and the hemp-based filter and a second outer skin disposed on a second side of the frame and the hemp-based filter.

5. The air filter apparatus of claim 4, wherein the hemp-based filter is enclosed within the frame, the first outer skin, and the second outer skin.

6. The air filter apparatus of claim 5, wherein the first outer skin defines an inlet to the air filter apparatus and the second outer skin defines an outlet to the air filter apparatus.

7. The air filter apparatus of claim 6, wherein:
the hemp-based filter includes a coating disposed thereon, and
the coating includes antibacterial properties.

8. The air filter apparatus of claim 7, wherein the coating comprises plant-based essential oils.

9. The air filter apparatus of claim 8, wherein the coating comprises hemp-based essential oils.

10. An air filtration system, comprising:
a housing;
a fan disposed within the housing;
an air filtration apparatus disposed within the housing, the air filtration apparatus comprising a hemp-based filter, the fan configured to pull air through the housing and the air filtration apparatus and exhaust a filtered air through an outlet of the air filtration system.

11. The air filtration system of claim 10, wherein the hemp-based filter includes a hemp hurd.

12. The air filtration system of claim 11, wherein the hemp hurd is a compressed hemp hurd.

13. The air filtration system of claim 11, wherein the air filtration apparatus further comprises a frame, the hemp hurd disposed within the frame.

14. The air filtration system of claim 13, further comprising a first outer skin disposed adjacent a first side of the frame and a second outer skin disposed adjacent a second side of the frame.

15. The air filtration system of claim 14, wherein the hemp hurd is enclosed within the frame, the first outer skin and the second outer skin.

16. The air filtration system of claim 10, wherein the hemp-based filter is configured to absorb carbon dioxide.

17. The air filtration system of claim 10, further comprising a plant-based coating disposed on the hemp-based filter.

18. The air filtration system of claim 17, wherein the plant-based coating is a hemp-based coating.

19. A method of manufacturing an air filtration apparatus, the method comprising:
disposing a hemp hurd within a frame;
coupling a first outer skin to a first side of the frame; and
coupling a second outer skin to a second side of the frame, the hemp hurd being enclosed by the frame, the first outer skin, and the second outer skin.

20. The method of claim 19, further comprising coating the hemp hurd with a plant-based coating, the plant-based coating including antibacterial properties.
